(19) United States
(12) Patent Application Publication
(10) Pub. No.: US 2008/0305218 A1
(43) Pub. Date: Dec. 11, 2008

(54) Ice cream kit

(75) Inventor: Michael Kahn, Livingston, NJ (US)

Correspondence Address: WEISS & WEISS, Suite 251, 300 Old Country Road, Mineola, NY, 11501, US

(73) Assignee: GZB CORPORATION

(21) Appl. No.: 11/811,257

(22) Filed: Jun. 8, 2007

(51) Int. Cl. A23G 9/50; A23G 9/04; B65D 85/78; A23G 9/48

(52) U.S. Cl. 426/91; 426/101; 426/120; 426/565

(57) ABSTRACT

A product, method and kit for making ice cream treats which allows a user to pick their own flavor(s) of ice cream, add toppings to the inside or outside of the ice cream treat and choose different covers for the ice cream.

### FIELD OF THE INVENTION

The present invention relates to a product, method and kit for making ice cream treats which allows a user to pick their own flavor(s) of ice cream, add toppings to the inside or outside of the ice cream treat and choose different covers for the ice cream.

### BACKGROUND OF THE INVENTION

U.S. Design Pat. Nos. D286,731, D283,748, D286,700 and D285,620 relate to the ornamental design for an ice cream sandwich.

U.S. Design Pat. No. D481,913 relates to an ice cream sandwich maker.

U.S. Patent Publ. Nos. 2003/0129280 and 2003/0134009 relate to a supported comestible comprising a frozen comestible or a non-frozen comestible that is supported by an edible support. The edible support has sufficient surface area inside the comestible to support the comestible. Protective, edible mess guards for the hands and fingers, protective, edible drip guards, free standing edible supports, and moisture proof barriers/coatings and sealants are included. Multi-ingredient supports, mini and large size confections, comestible kits, stick alignments device, and an all in one mold and packaging apparatus for frozen confections is also provided.

U.S. Pat. No. 6,156,357 relates to a frozen confection type food product and method for making same. An edible frozen confection food product and method comprises providing an elongated core of frozen confection and an elongated edible receptacle for receiving and retaining the core. The receptacle comprises a cake-like bun having first and second portions in part separated from one another to form a generally channel-shaped pocket, but joined. The core is disposed in the pocket and occupies a portion of the pocket less than a whole of the pocket.

U.S. Pat. Nos. 4,580,476 and 4,644,901 relate to a method and apparatus for making chocolate-coated ice cream cookie sandwiches. The patent teaches a conveyor system for transporting the ice cream cookie sandwich through the various stages of its manufacture along with uniquely constructed ice cream brick slicing machines and a unique chocolate coating machine.

U.S. Pat. No. 4,500,553 relates to a method of producing a frozen dual-textured confection. The patent teaches a method of producing a frozen, dual-textured confection comprising a cream and a gelatin-containing aerated phase and a natural or simulated fruit phase.

U.S. Pat. No. 5,652,005 relates to a method of producing filled sandwich cookies to be fed by an auger into an ice cream stream to produce ice cream with filled cookies comprising baking dough in units of multiple cookie elements, of substantially round shape. Filling is applied to each cookie element of a portion of the units which have been produced, sandwiching other units onto the filling, and then separating the multiple sandwich cookie units into individual sandwich cookies.

US patent pub no. 2006/0093708 relates to a ice cream novelty product and the method of manufacturing the product includes tow thin layers of biscotti baked goods, approximately ¼ inch thick, on opposing surfaces of an intermediate ice cream layer, approximately ¾ inch thick. On the surface of each biscotti layer which comes in contact with the ice cream layer is a layer of thin, couverture chocolate. The couverture chocolate is a combination of chocolate liquor and cocoa butter.

U.S. Pat. No. 5,789,008 relates to an ice cream sandwich and method of making the same. The ice cream sandwich includes a layer of ice cream intermediate a pair of crispy cookies. The cookies resist migration of moisture from the ice cream and remain crisp during storage. An edible oil and food membrane on the cookies prevents moisture in the ice cream from being absorbed by the cookies.

US patent pub no. 2004/0166207 relates to a food kit for components of chilled and frozen deserts. The kit preferably includes a plurality of compartments for the ingredients with one of the compartments being filled with a dessert component such as ice cream, yogurt or pudding. The second compartment is filled with a component such as cookies or wafers and the third with a topping component such as fudge, syrup, or bits of candy.

### SUMMARY OF THE INVENTION

The present invention relates to a kit for making ice cream treats which allows a user to pick their own flavor(s) of ice cream, add toppings to the inside or outside of the ice cream treat and choose different covers for the ice cream.

It is an object of the present invention for the ice cream to be made with two flavors by combining the two different ice cream halves with some kind of stuff in the middle that is placed there by an individual or by a store worker.

It is an object of the present invention for a holder to be placed in the ice cream for holding the ice cream.

It is an object of the present invention for the ice cream product to comprise a first layer that is made of a cookie or cake. It is an object of the present invention for the cookie or cake to come in diameters of from approximately 1 inch (minis) to approximately 12 inches (supersize). It is an object of the present invention for the cookie or cake to have a thickness of approximately ⅛ of an inch to approximately 1 inch. It is an object of the present invention for a layer of ice cream to be placed on top of the cookie or cake layer. It is an object of the present invention for the layer of ice cream to have a thickness of approximately ⅛ inch to approximately 1 inch. It is an object of the present invention for the layer of ice cream to be approximately ½ inch less in diameter than the diameter of the cookie or cake layer. It is an object of the present invention for the ice cream layers to have a diameter of approximately ¾ inch to 11½ inches.

It is an object of the present invention for the ice cream to be flat on top. It is an object of the present invention for a sheet of wax paper or other material to be placed on top of the ice cream prior to packaging.

It is an object of the present invention for the ice cream to come in a variety of flavors.

It is an object of the present invention to have unlimited combinations of ice cream sandwich combinations.

It is an object of the present invention for a middle layer to be comprised of a filling such as cookie crumbs, chocolate chips, confection sprinkles, and other such items.

It is an object of the present invention for the middle layer to be a flavored syrup.

It is an object of the present invention for the middle layer to be a fruit topping.

It is a further object of the invention for the ice cream treat to be rolled over another topping to coat the outer exposed areas.

It is an object of the present invention for the ice cream to be dipped in a chocolate liquid that hardens when it cools.

It is an object of the present invention for the ice cream and cookie layer to have a predrilled hole for inserting a holder.

It is an object of the present invention for the device to comprise a handle that can be held by a user, a protrusion section which is placed inside the ice cream and outer layer ice cream.

It is an object of the present invention for the handle to have a logo printed on it.

It is an object of the present invention for the item to be held to be in the form of an ice cream sandwich, flying saucer or other type of ice cream which is normally held in a person's hands.

It is an object of the present invention for the holder to be inserted into the ice cream prior to the item being frozen.

It is an object of the present invention for multiple types of handles to be used with multiple types of protrusions so that the tops and bottoms can be used interchangeably.

It is an object of the present invention to add toppings on top of either or both halves of the ice cream layers prior to putting the layers together.

It is an object of the present invention to have indentations in one or both of the ice cream layers to receive toppings prior to putting the ice cream halves together.

It is an object of the present invention to have indentations in the ice cream layer which create different pictures such as a face for placing the toppings in.

The present invention relates to a kit comprising compartments for receiving the ice cream halves, toppings, and holders for the ice cream.

The present invention relates to a method for making an ice cream product comprising; taking one half of an ice cream product which is comprised of ice cream and a cookie or cake product and placing it together with a second ice cream product comprised of ice cream and a cookie or cake product.

It is an object of the present invention to provide a holder for the ice cream product which is placed through both layers both ice cream halves to hold the products together and to be used as a holder for the user.

It is an object of the present invention to provide toppings that can be placed inside the ice cream before the ice cream halves are placed together.

The ice cream halves can be held together for consumption in several manners. First the holder can be placed through both ice cream layers to hold the layers together. In another embodiment a sticky edible substance can be placed between the halves to hold them together, such as a syrup. In a further embodiment, when the halves are ready to be added together the ice cream can be partially melted and then refrozen to seal the halves together.

### BRIEF DESCRIPTION OF THE DRAWINGS

FIG. 1 illustrates a view of the ice cream product in its unassembled fashion.

FIG. 2 shows one half of the ice cream product of the present invention.

FIG. 3 shows one half of the ice cream product of the present invention.

FIG. 4 shows a kit comprising the ice cream product of the present invention.

FIG. 5 illustrates a view of the device being attached to an object held by a user.

FIG. 6 shows the two separate halves of the ice cream product being inserted into the holder.

FIG. 7 shows a cross section of the device in FIG. 5 inserted into an object.

FIG. 8 shows an unassembled holder of present invention.

FIG. 9 shows an unassembled holder of present invention.

FIG. 10 shows a holder for an ice cream product prior to being assembled and inserted into the ice cream product.

FIG. 11 shows a holder for an ice cream product of the present invention.

FIG. 12 shows a cross section of FIG. 11.

FIG. 13 shows a holder for an ice cream product of the present invention.

FIG. 14 shows a cross section of FIG. 13.

FIG. 15 shows a holder for an ice cream product of the present invention.

FIG. 16 shows a holder being inserted into the ice cream product of the present invention.

FIG. 17 shows a holder being inserted into the ice cream product of the present invention.

FIG. 18 shows the ice cream product being held by a holder of the present invention.

FIG. 19 shows the ice cream product being held by a holder of the present invention.

### DETAILED DESCRIPTION

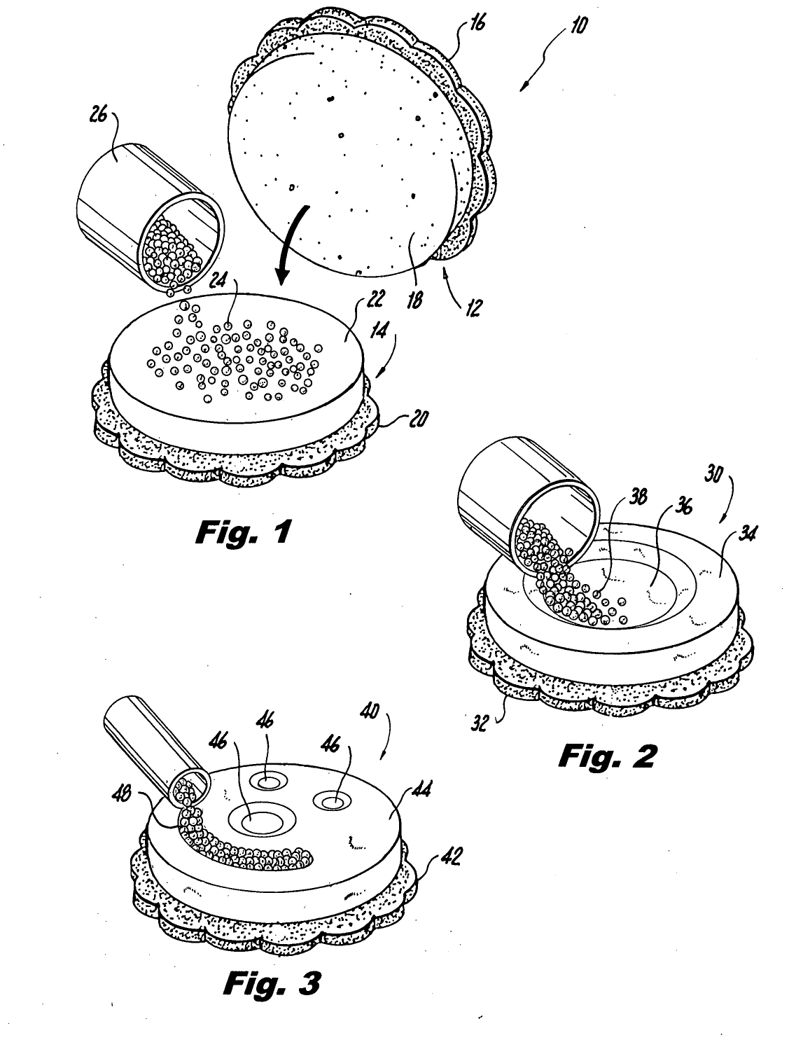

FIG. 1 shows the ice cream product 10 broken up into two halves 12 and 14. Half 10 comprises a cake or cookie layer 16 and an ice cream layer 18. Half 14 comprises cake or cookie layer 20 and ice cream layer 22. Toppings 24 can be added to either ice cream layer 22 or ice cream layer 18. The toppings can be part of a kit an enclosed in a container 26. The ice cream layers 18 and 22 can comprise the same ice cream flavor or different ice cream flavors. Further the cake or cookie layer 16 and 20 can be made up of the same cake or cookie layer or different cake or cookie layer.

FIG. 2 shows an ice cream half product 30 comprising a cookie or cake layer 32 and an ice cream layer 34. The ice cream layer 24 has an indentation 36 for receiving toppings 38.

FIG. 3 shows an ice cream product 40 of the present invention comprising a cookie or cake layer 42 and an ice cream layer 44. The ice cream layer 44 has several indentations 46 which make up a face in the ice cream layer 44. Toppings 48 can then be inserted into the indentations 46.

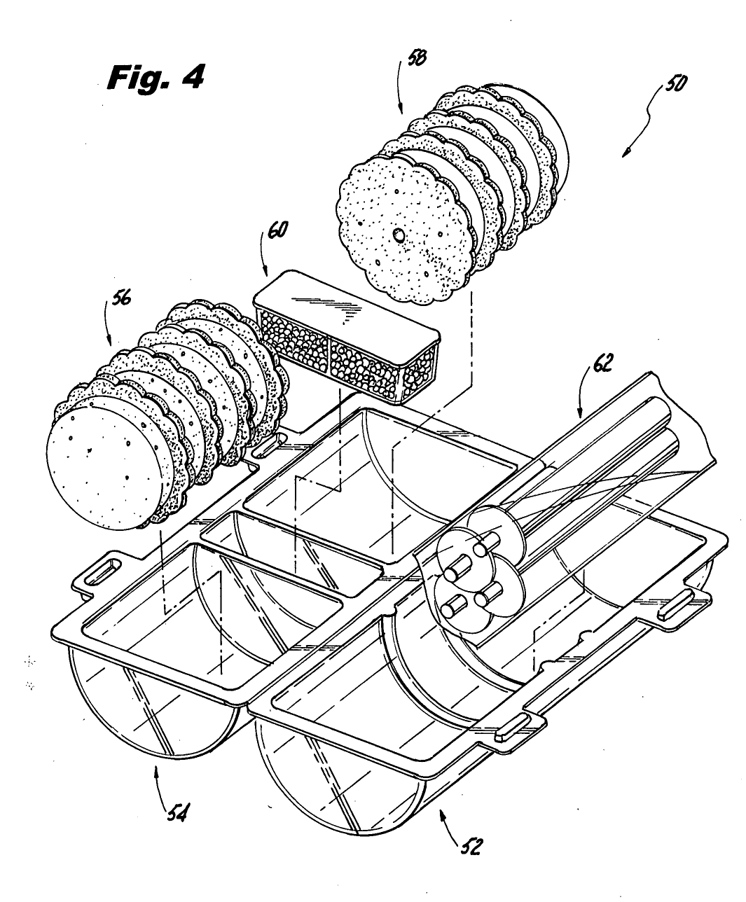

FIG. 4 shows a kit 50 for the ice cream product of the present invention. The kit 50 consists of a container 52 which has sections 54 for placing the different ice cream products in. In one section 54, ice cream halves 56 which comprise an ice cream layer and a cookie or cake layer are placed and a separate section for different types of ice cream or cookie layers 58 are placed. A toppings container 60 is placed in section 54 within the kit 50 and holders 62 are placed in a further section in the kit.

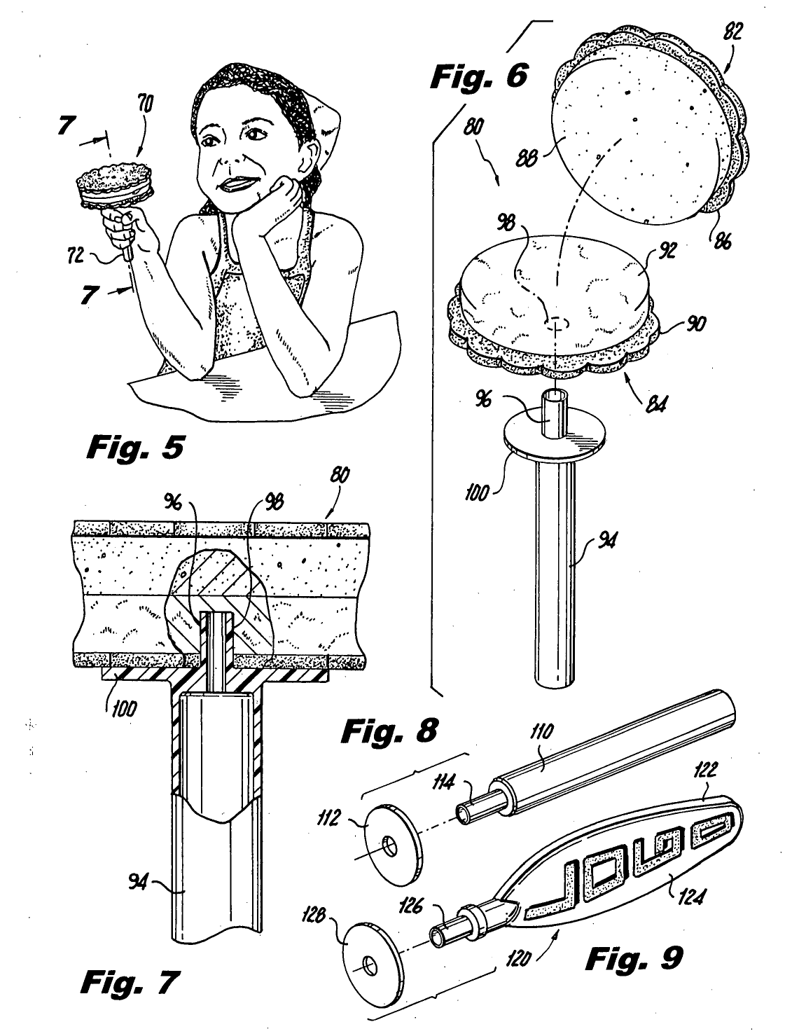

FIG. 5 shows a person holding the assembled ice cream product 70 by the holder 72.

FIG. 6 shows the unassembled ice cream product 80 comprising halves 82 and 84. Half 82 comprises a cookie or cake layer 86 and an ice cream layer 88. Ice cream half 84 comprises a cookie or cake layer 90 and an ice cream layer 92. The ice cream product halves 82 and 84 are placed together and a holder 94 having a protrusion 96 is placed through the ice cream product which may have an opening 98 for placing the protrusion through. The holder may also have a slip prevention disk 100.

FIG. 7 is a cross section of the holder and object 70 and 72 shown in FIG. 5.

FIG. 8 shows the handle 110, the slip prevention disk 112, and the protrusion 114.

FIG. 9 shows the holder 120 having a handle 122 which has a larger surface area for putting on a logo 124. The holder 120 further has the protrusion 126 and the slip prevention disk 128.

FIG. 10 shows the ice cream product 150 having a hole 152 which is placed in a protrusion 154. The protrusion is above a slip prevention disk 156. The protrusion 154 and slip prevention disk 156 are placed on a handle 158.

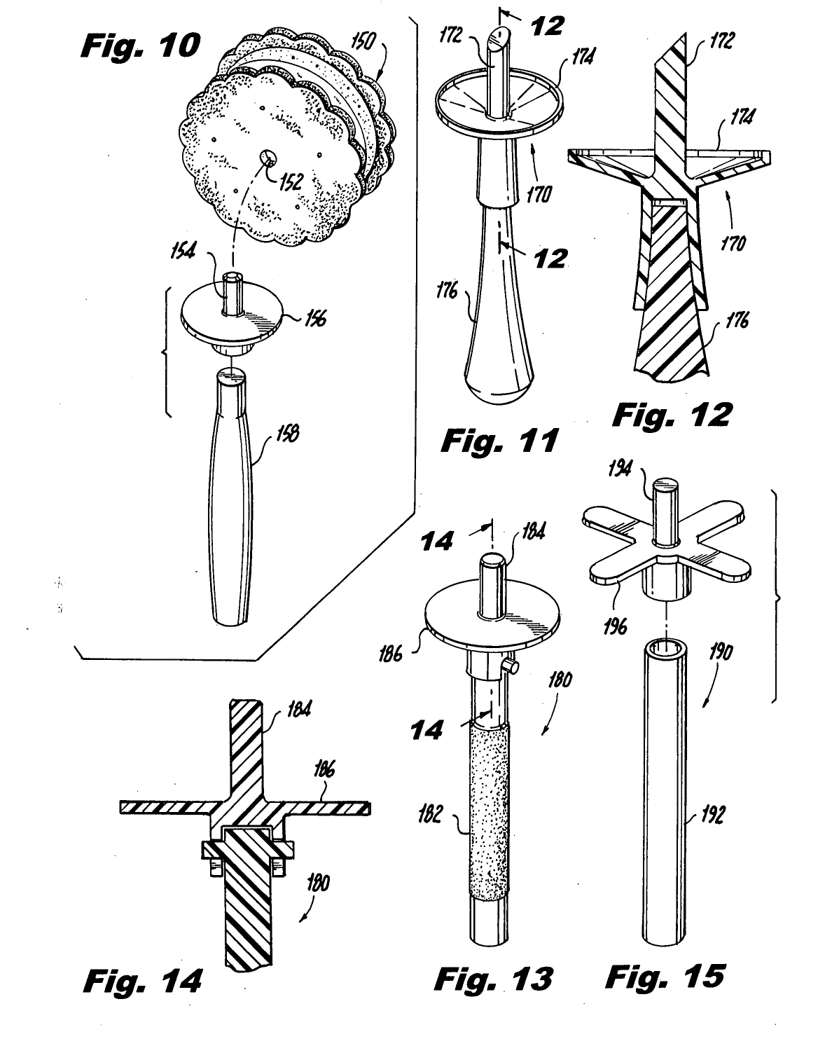

FIG. 11 shows a holder 170 for an ice cream product of the present invention. The holder has a protrusion 172 a slip prevention disk 174 and a handle 176.

FIG. 12 shows a cross section of the holder shown in FIG. 11.

FIG. 13 shows a holder 180 having a handle 182, a protrusion 184 and a slip prevention disk 186.

FIG. 14 shows the cross section of the holder shown in FIG. 13.

FIG. 15 shows a holder for the ice cream product 190 having a handle 192, a protrusion 194 and a slip prevention disk 196.

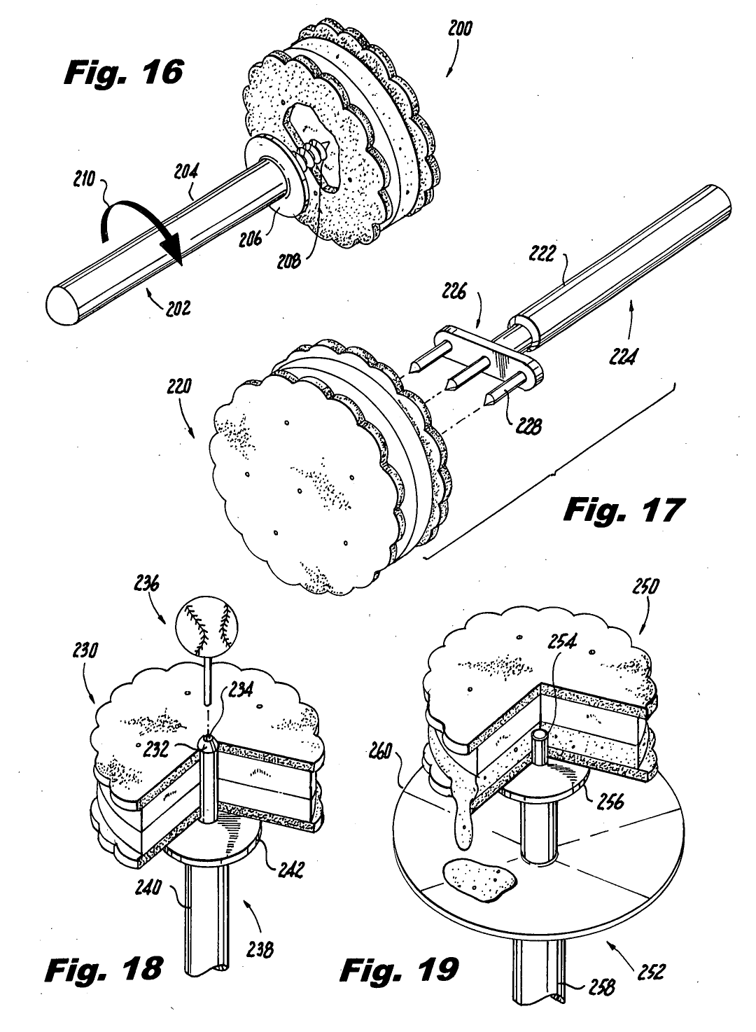

FIG. 16 shows the ice cream product 200 having a holder 202. Holder 202 comprises a handle 204 having a slip prevention disk 206 and a protrusion 208. The protrusion 208 is in the form of a screw which can be screwed into the bottom of the ice cream product 200 as shown by arrow 210.

FIG. 17 shows an ice cream product 220. A holder 222 is comprised of a handle 224 and a protrusion section 226 which is made up of multiple protrusions 228. The protrusions 228 are placed into the ice cream product 220 for holding the ice cream product.

FIG. 18 shows the ice cream product 230. A protrusion 232 is seen protruding through the entire ice cream product 230. The protrusion 232 has a hole 234 in its center for receiving a novelty product 236. The holder 238 is further comprised of a handle 240 and a slip prevention disk 242.

FIG. 19 shows the ice cream product 250 sitting on top of a holder 252. The holder 252 is comprised of a protrusion 254, a slip prevention disk 256 and a handle 258. Below the slip prevention disk is a drip catching disk 260.

The following are toppings which are not limited, but can include the following:

Butterfinger, Heath bar, Andes mints, M & M plain, Nestles Church, Reese cup, Kit Kat bar, Snicker Bar, Baby Ruth, fudge brownie, Reese Pieces, mini Reese Pieces, M & M mini, Oreo cookies, M & M plain, cookies & cream, Take 5, Gummi bears or worms, peanuts, pecans, cookie dough, cheesecake pieces, chips, assorted, chips, chocolate, chips, no sugar added, chips, white chocolate, chips, yogurt, chips, yogurt minis, nonpareils, rainbow mini, nonpareils, white mini, sprinkles, chocolate and rainbow.

The following are coatings/dips which are not limited, but can include, butterscotch, lemon lime, banana, strawberry, strawberry banana, blue raspberry, bubble gum, pina colada, lime, key lime, rootbeer, caramel, grape, cotton candy, cherry, orange, coconut, chocolate peanut butter, peanut butter, black raspberry, vanilla, dark chocolate and cappuccino.

The following are ice cream flavors, which are not limited, but can include, all-american cherry, almond, almond cinnamon, almond coconut, almond fudge, amaretto, angel food cake, apple, apple cinnamon, apple pie, apple spice, apple strudel, apricot, apricots n′ cream, avocado, banana, banana colada, banana cream pie, banana foster, banana fudge, banana mango, banana nut, banana orange, banana rocky road, banana split, banana strawberry, beech nut, Belgian dark chocolate, berry berry, dutch fudge, biscuit tortoni, bisque, bittersweet chocolate, black cherry, black forest cake, black raspberry, black Russian, black walnut, blackberry, blackberry cheesecake, blackberry chocolate, blond brownie sundae, blue ribbon berry pie, blueberries and cream, blueberry, blueberry cheesecake, blueberry colada, blueberry malt, blueberry maple, blueberry swirl, blueberry vanilla, Bordeaux cherry, brownie, brownie cookie dough, bubble gum, burgundy cherry, burnt almond, butter almond, butter brickle, butter caramel, butter crème, butter crisp, butter crunch, butter fudge, butter pecan, butternut crunch, butterscotch, butterscotch fudge, butterscotch honey almond, butterscotch ripple, candied sweet potato, candy, cantaloupe, caramel, caramel cashew, caramel fudge, caramel nut, caramel pecan, caramel toffee bar heaven, carob, carob honey, cashew, cashew honey, cashew praline parfait, cheesecake cherry, cherry caramel, cherry cheesecake, cherry cordial, cherry Garcia, cherry nut, cherry ribbonette, cherry vanilla, chestnut, chocolanilla, chocolate, chocolate almond, chocolate banana, chocolate banana mouse, chocolate butter toffee, chocolate butterscotch, chocolate cheesecake, chocolate cherry, chocolate cherry amaretto, chocolate chestnut, chocolate chip, chocolate chip cheesecake, chocolate chip cookie dough, chocolate chip vanilla, chocolate chocolate chip, chocolate chocolate fudge, chocolate chunks, chocolate cinnamon, chocolate coconut, chocolate cookie, chocolate cookie dough, chocolate covered banana, chocolate fudge brownie, chocolate gelato, chocolate grape-nuts, chocolate hazelnut, chocolate hazelnut praline, chocolate heath bar crunch, chocolate honey almond, chocolate malt, chocolate malt with caramel, chocolate marshmallow, chocolate marshmallow with cookies, chocolate mint, chocolate mousse, chocolate orange cointreau fudge, chocolate orange pineapple, chocolate peanut, chocolate peanut butter cookie dough, chocolate peanut butter, chocolate peanut butter cup, chocolate peanut butter chunk, chocolate pecan, chocolate pecan pie, chocolate peppermint, chocolate raspberry, chocolate raspberry fudge swirl, chocolate raspberry swirl, chocolate raspberry truffle, chocolate ribbonette, chocolate sorbet, chocolate strawberry truffle, chocolate swiss chocolate almond, chocolate walnut, chunky blueberry, cinnamon, cinnamon bun, cinnamon nut, cinnamon swirl, cinnamon vanilla cake crunch, clark bar, coconut, coconut almond fudge, coconut almond fudge chip, coconut caramel almond, coconut cream, coconut cream pie, coconut fudge, coconut pineapple, coconut sorbet, coconut tortini, cookie dough, cookies 'n cream, cool mint, cotton candy, country pumpkin, cranberry, curacao, currant, dark chocolate and pecans, dark chocolate and orange mint, date, date crunch, date nut, date nut pudding, deep dark chocolate, deep dish apple pie, devils food cake, dulce de leche, dutch apple, egg custard, egg nog, eggnog, English butter toffee, English toffee, entangled mints, ethan almond, fig, fig nut, French chocolate, French custard, French lavender, French nougat, French vanilla, fresh Georgia peach, frommage, fruit, fudge, fudge marble, fudge ripple, galactic chocolate swirl, german chocolate cake, gimmie smore, ginger, ginger apricot, ginger honey, ginger honey rum raisin, graham crunch, granola, granola banana, grape, grape-nuts, grapefruit, grapenut, harvest peach, hazelnut, heath bar crunch, heavenly hash, honey almond, jam 'n cream, jelly bean, kakadu plum, key lime pie, kitchen sink, kiwi, lemon, lemon anise, lemon cake crunch, lemon chip, lemon custard, lemon lime, lemon pineapple, lemon pistachio, lemon sherbet, lemon sorbet, licorice, lime, lime sherbet, Longanberry, M and M, macadamia brittle, macadamia nut, macadamia nut toffee, macaroon, mackinac island fudge, mallow, malt, malted grape-nuts, malted milk ball, mandarin chocolate, mango, mango lime, mango sorbet, mango sunset sorbet, maple, maple blueberry, maple nut, maple walnut, maraschino cherry, marshmallow, marshmallow bon bon chocolate, melon, Mexican chocolate, milk chocolate and roasted peanuts, mint, mint avalanche, mint chiffon, mint chip, mint chocolate, mint choclate chip, mint chocolate cookie, mint chocolate fudge, mint grapefruit, mint with oreo, molasses, mud pie, neopolitan, nectarine, nesselrode, new England pumpkin, new york cheesecake, new york strawberry cheesecake, new york super fudge chunk, nougat, nut, nut brittle, nutty waffle cone, old fashioned vanilla, orange, orange chocolate chip, orange cream, orange custard chocolate chip, orange pineapple, orange sherbet, oranges and cream, orchid vanilla, passion fruit and red rose petals sorbet, passion fruit orange, peach, peach cheesecake, peach mallow, peach raspberry trifle, peaches 'n cream, peanut, peanut brittle, peanut butter, peanut butter and jelly, peanut butter and fudge, peanut butter chocolate chunk, peanut butter cup, peanut butter fudge, peanut butter parfait, peanut popcorn, pear, pecan brittle, pecan caramel truffle, pecan crunch, pecan pie, pecan praline, peppermint, peppermint crunch, peppermint stick, persimmon, pine nut, pineapple, pineapple coconut, pineapple grapefruit, pineapple nut, pineapple orange, pistachio, pistachio gelato, plum, plum pudding, praline, praline and cream, praline fudge, praline pecan, prune, prune nut, pumpkin, pumpkin and spices gelato, pumpkin ripple, pumpkin spice, rainbow sherbet, raisin, raspberries 'n cream, raspberry, raspberry and spices sorbet, raspberry nectarine sorbet, rhubarb, rocky road, rum coconut, rum raisin, saffron, saffron honey, sambucca chocolate, sesame, sesame almond, southern pecan pie, spumoni, sticky bun, strawberries 'n cream, strawberry, strawberry banana, strawberry cheesecake, strawberry pineapple, sugar plum, sunseed, sweet cream and cookies, sweet cream with oreo, sweet potato, sweet potato pie, swiss almond, tahini, teaberry, Tennessee mud, thick fudge, tiramisu, toasted almond, toasted nut, toffee, toffee creme, torroncino, triple caramel chunk, triple chocolate, tutti-frutti, vanilla, vanilla and chocolate mint patty, vanilla bean, vanilla cake crunch, vanilla chocolate chunk, vanilla fudge, vanilla gelato, vanilla heath bar crunch, vanilla peanut butter, vanilla swiss almond, vanilla with oreo, watermelon sherbet, white chocolate, white chocolate and apricots, white chocolate chip, white chocolate macadamia toffee, white ginger lime and parsley sorbet, wild berry gelato, wild marine blueberry, wild Roselle flower, wildberry.

What is claimed is:

1. A kit for making ice cream treats products comprising:
ice cream layers;
an outer layer made of cookie or cake;
toppings;
a compartmentalized container for holding said ice cream layers, cookie or cake layers and toppings.

2. The kit of claim 1 further comprising holders for holding said ice cream treats.

3. The kit of claim 1 wherein said ice cream layers are made of different flavors.

4. An ice cream product comprising:
two ice cream halves;
said ice cream halves each comprising a cake or cookie layer and an ice cream layer;

5. The ice cream product of claim 4 wherein said cookie or cake layer is approximately 1 inch to 12 inches in diameter.

6. The ice cream product of claim 4 wherein said cookie or cake layer has a thickness of approximately ⅛ inch to 1 inch.

7. The ice cream product of claim 4 wherein said layer of ice cream has a thickness of approximately ⅛ inch to approximately 1 inch.

8. The ice cream product of claim 4 wherein said layer of ice cream is approximately ½ inch less in diameter than diameter of said cookie layer.

9. The ice cream product of claim 4 wherein said ice cream layers have a diameter of approximately ¾ inch to 11½ inches.

10. The ice cream product of claim 4 wherein said ice cream layer is flat on top.

11. The ice cream product of claim 4 wherein a sheet of wax paper or other material is placed on top of said ice cream layer prior to packaging.

12. The ice cream product of claim 4 wherein said ice cream comes in a variety of flavors.

13. The ice cream product of claim 4 wherein a middle layer is placed between said two ice cream halves said middle layer comprising a filling.

14. The ice cream product of claim 13 wherein said filling comprises cookie crumbs, chocolate chips, confection sprinkles, and other such items.

15. The ice cream product of claim 4 wherein said ice cream product is rolled over another topping to coat outer exposed areas of said ice cream product.

16. The ice cream product of claim 4 wherein said ice cream product is dipped in a chocolate liquid that hardens when it cools.

17. The ice cream product of claim 4 wherein at least one of said ice cream halves has a predrilled hole for inserting a holder.

18. The ice cream product of claim 4 further comprising:
a holder which holds said ice cream product.

19. The ice cream product of claim 18 wherein said holder comprises a handle that can be held by a user, a protrusion section which is placed inside said ice cream product.

20. The ice cream product of claim 19 wherein said handle has a logo printed on it.

21. The ice cream product of claim 18 wherein said holder is inserted into said ice cream product prior to said ice cream product being frozen.

22. The ice cream product of claim 19 wherein multiple types of handles are used with multiple types of protrusions.

23. The ice cream product of claim 4 wherein toppings are added on top of either or both halves of said ice cream layers prior to putting said layers together.

24. The ice cream product of claim 4 wherein one or both of said ice cream layers have indentations.

25. The ice cream product of claim 24 wherein said indentations receive toppings prior to putting said ice cream halves together.

26. The ice cream product of claim 24 wherein said indentations in said ice cream layer create different pictures.

27. A method for making an ice cream product comprising:
taking one half of an ice cream product which is comprised of ice cream and a cookie or cake product and placing it together with a second half of an ice cream product comprised of ice cream and a cookie or cake product.

28. The method of claim 27 further comprising:
placing a holder through said one half and/or second half of said ice cream product to hold said ice cream products together.

29. The method of claim 27 further comprising:
placing toppings on inside of said ice cream half before ice cream halves are placed together.

30. The method of claim 27 further comprising:
placing a holder having a protrusion through said ice cream product halves.

31. The method of claim 27 wherein said holder further comprises a slip prevention disk.

32. The method of claim 28 wherein either or both of said ice product halves have a hole which is placed in a protrusion.

33. The method of claim 30 wherein said protrusion comprises a screw which is screwed into bottom of the ice cream product half.
